(19) United States
(12) Patent Application Publication
(10) Pub. No.: US 2018/0359932 A1
(43) Pub. Date: Dec. 20, 2018

(54) SYSTEMS AND METHODS FOR MANAGING NUTRIENT DOSAGE FOR A GROW POD

(71) Applicant: Grow Solutions Tech LLC, Lehi, UT (US)

(72) Inventors: Gary Bret Millar, Highland, UT (US); Mark Gerald Stott, Eagle Mountain, UT (US); Todd Garrett Tueller, American Fork, UT (US)

(21) Appl. No.: 15/996,340

(22) Filed: Jun. 1, 2018

Related U.S. Application Data
(60) Provisional application No. 62/519,346, filed on Jun. 14, 2017.
(60) Provisional application No. 62/519,633, filed on Jun. 14, 2017.

(51) Int. Cl. A01G 7/00; A01G 9/24; A01C 21/00; G06Q 50/02

(52) U.S. Cl. CPC A01G 7/00; A01G 9/247; A01G 31/042; G06Q 50/02; A01C 21/005

(57) ABSTRACT

A method for applying recipes in a plurality of grow pods includes receiving a first modified recipe from a first grow pod, the first grow pod including a first physical parameter, receiving a second modified recipe from a second grow pod, the line grow pod including a second physical parameter that is different than the first physical parameter, receiving a request from a third grow pod for a modified recipe, determining that the third grow pod includes the first physical parameter or the second physical parameter, in response to determining that the third grow pod includes the first physical parameter, implementing the first modified recipe at the third grow pod, and in response to determining that the third grow pod includes the second physical parameter, implementing the second modified recipe at the third grow pod.

### CROSS REFERENCE TO RELATED APPLICATIONS

This application claims the benefit of U.S. Provisional Application Ser. No. 62/519,346 filed on Jun. 14, 2017 and entitled “Systems and Methods for Collecting Improved Growing Procedures from a Grow Pod,” and U.S. Provisional Application Ser. No. 62/519,633 filed on Jun. 14, 2017 and entitled “Systems and Methods for Managing Nutrient Dosage for a Grow Pod,” the contents each of which are hereby incorporated by reference in their entirety.

### TECHNICAL FIELD

Embodiments described herein generally relate to systems and methods for managing nutrient dosages for a grow pod and, more specifically, to providing nutrients containing water to plants in moving carts based on nutrient dosages.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

Controlled environment growing systems may mitigate many of the negative factors affecting traditional harvests. These controlled environment growing systems may include a predetermined nutrient dosage to be applied to plant matter within the growing system, a predetermined amount of light to be provided to the plant matter within the growing system, and the like. However, this may not account for conditions particular to some the controlled environment growing systems, which may reduce crop yields and/or increase operating costs. Accordingly, a need exists for improved systems and methods for managing sustenance dosages in a controlled environment growing system and collecting improved growing procedures.

### SUMMARY

In one embodiment, a system for implementing modified recipes in a plurality of grow pods includes a remote computing device communicatively coupled to the assembly line grow pod, the remote computing device including a processor and a computer readable and executable instruction set, which when executed, causes the processor to receive a first recipe associated with a first physical parameter, receive a request from the assembly line grow pod for a recipe, determine whether the assembly line grow pod includes the first physical parameter, in response to determining that the assembly line grow pod includes the first physical parameter, implement the first recipe at the assembly line grow pod, in response to determining that the assembly line grow pod does not include the first physical parameter, determine a physical parameter of the assembly line grow pod, modify at least one characteristic of the first recipe to create a modified recipe based at least in part on the determined physical parameter of the assembly line grow pod, and implement the modified recipe at the assembly line grow pod.

In another embodiment, a method for applying recipes in a plurality of assembly line grow pods includes receiving a first modified recipe from a first assembly line grow pod, the first assembly line grow pod including a first physical parameter, receiving a second modified recipe from a second assembly line grow pod, the second assembly line grow pod including a second physical parameter that is different than the first physical parameter, receiving a request from a third assembly line grow pod for a modified recipe, determining that the third assembly line grow pod includes the first physical parameter or the second physical parameter, in response to determining that the third assembly line grow pod includes the first physical parameter, implementing the first modified recipe at the third assembly line grow pod, and in response to determining that the third assembly line grow pod includes the second physical parameter, implementing the second modified recipe at the third assembly line grow pod.

In yet another embodiment, a a method for implementing a recipe within an assembly line grow pod includes identifying a type of plant matter to be grown within the assembly line grow pod, retrieving a stored recipe from a remote computing device based at least in part on the type of plant matter, modifying at least one characteristic of the stored recipe to create a modified recipe based at least in part on a physical parameter of the assembly line grow pod, dispensing nutrients to at least one cart in accordance with the modified recipe, detecting an output of plant matter on the at least one cart from dispensing the modified recipe, determining that the output of plant matter from dispensing the modified recipe exceeds a predetermined threshold, in response to determining that the output of plant matter from dispensing the modified recipe exceeds the predetermined threshold, storing the modified recipe on the remote computing device, and dispensing nutrients to a second plurality of carts in accordance with the stored modified recipe.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an assembly line grow pod, according to one or more embodiments shown and described herein;

FIG. 2 schematically depicts the assembly line grow pod of FIG. 1 with an outer shell removed, according to one or more embodiments shown and described herein;

FIG. 3 schematically depicts a rear perspective view of the assembly line grow pod of FIG. 2, according to one or more embodiments shown and described herein;

FIG. 4 schematically depicts a section view of the assembly line grow pod along section 4-4 depicted in FIG. 2 and a nutrient doser in fluid communication with a plurality of water manifolds, according to one or more embodiments shown and described herein;

FIG. 5 schematically depicts a computing device of the assembly line grow pod of FIG. 1, according to one or more embodiments shown and described herein;

FIG. 6 schematically depicts a remote computing device communicatively coupled to the assembly line grow pod of FIG. 1, according to one or more embodiments shown and described herein;

FIG. 7 schematically depicts a network connected to the computing device of FIG. 5, according to one or more embodiments shown and described herein;

FIG. 8 schematically depicts a flowchart for a method of implementing a modified recipe on an assembly line grow pod, according to one or more embodiments shown and described herein;

FIG. 9 schematically depicts a flowchart for a method of detecting an output of plant matter from applying a modified recipe on an assembly line grow pod, according to one or more embodiments shown and described herein;

FIG. 10 schematically depicts a flowchart for a method for identifying a modified grow recipe, according to one or more embodiments shown and described herein; and

FIG. 11 schematically depicts a flowchart for a method of modifying a recipe based at least in part on determined physical parameters of an assembly line grow pod, according to one or more embodiments shown and described herein.

### DETAILED DESCRIPTION

Embodiments disclosed herein include multiple assembly line grow pods communicatively coupled to one another via a central computing entity. The multiple assembly line grow pods may include a first set of grow pods having tracks of a first length and a second set of grow pods having tracks of a second length. In other embodiments, the multiple assembly line grow pods may have different numbers of water manifolds and/or different overall sizes of the assembly line grow pod. The central computing entity is configured to receive a modified recipe from a grow pod of the first set, associate the modified recipe with the first set of grow pods, and provide the modified recipe to the first set of grow pods for use in future harvests. In this way, improved recipes may be shared among grow pods with similar characteristics. The systems and methods for managing nutrient dosage for a grow pod incorporating the same will be described in more detail below.

As used herein, the term “plant matter” may encompass any type of plant and/or seed material at any stage of growth, for example and without limitation, seeds, germinating seeds, vegetative plants, and plants at a reproductive stage.

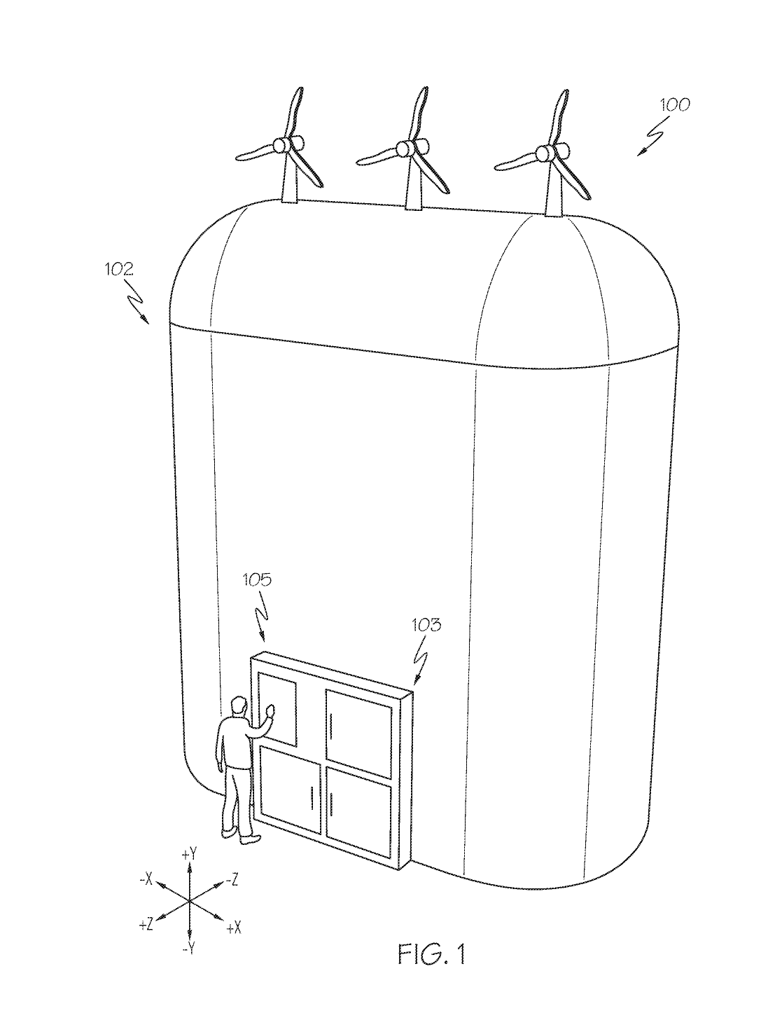

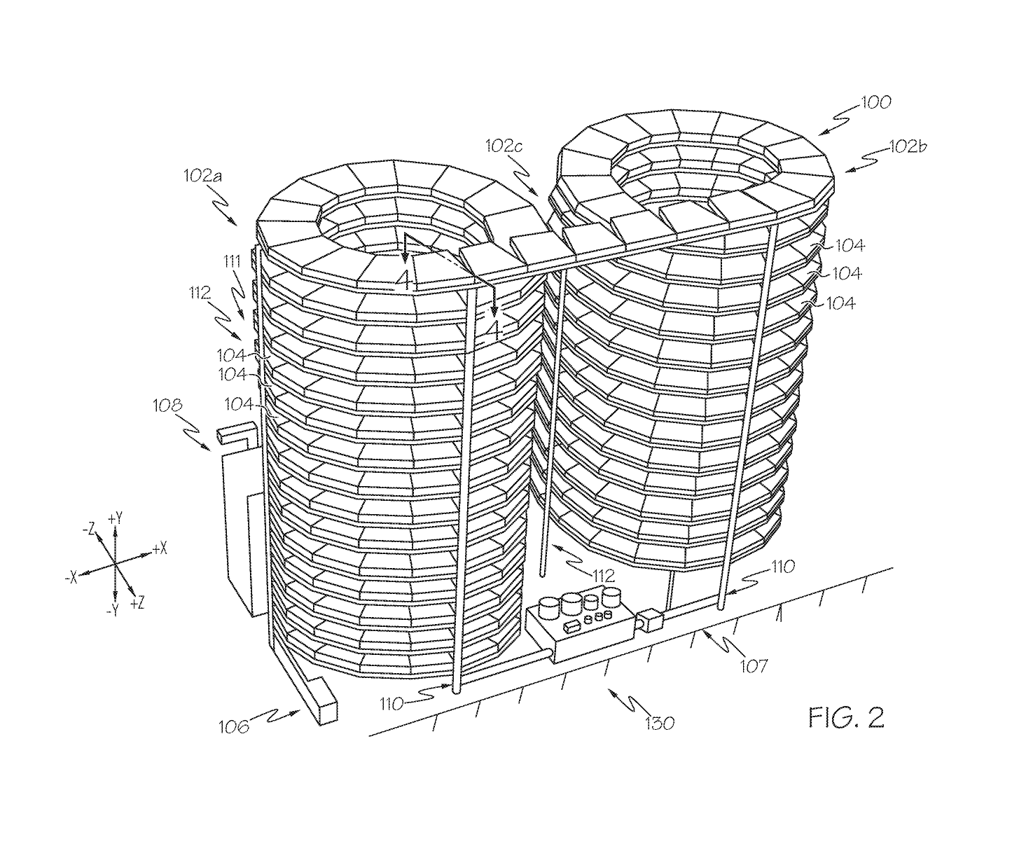

Referring initially to FIG. 1, an assembly line grow pod 100 is schematically depicted. In the embodiment depicted in FIG. 1, the assembly line grow pod 100 includes an external shell 102 that at least partially encapsulates an interior of the assembly line grow pod 100. The external shell 102 may shield the interior of the assembly line grow pod 100 from external environmental elements, such as rain and external temperature fluctuations, such that the interior of the assembly line grow pod 100 may be a generally controlled environment. The assembly line grow pod 100 may include a control panel 103 with a user input/output device 105, such as a touch screen, monitor, keyboard, mouse, etc. coupled to the external shell 102. The control panel 103 and/or the user input/output device 105 may be communicatively coupled to and allow a user to interface with a master controller 106 (FIG. 2) of the assembly line grow pod 100, as described in further detail herein.

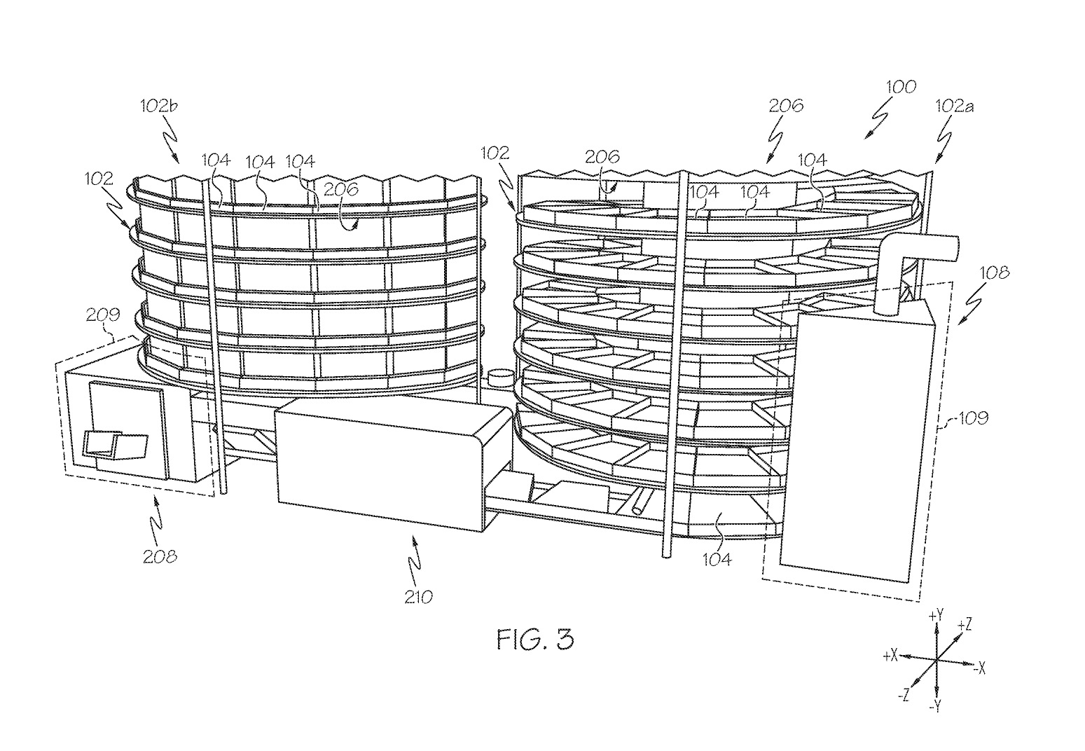

Referring to FIGS. 2 and 3, the assembly line grow pod 100 is depicted with the external shell 102 (FIG. 1) removed, with FIG. 2 showing a front perspective view and FIG. 3 showing a rear perspective view of the assembly line grow pod 100. The assembly line grow pod 100 includes a track 102 that is configured to allow one or more carts 104 to travel along the track 102. In the embodiment depicted in FIG. 2, the assembly line grow pod 100 includes an ascending portion 102a, a descending portion 102b, and a connection portion 102c between the ascending portion 102a and the descending portion 102b. The track 102 at the ascending portion 102a moves upward in a vertical direction (e.g., in the +/−y-direction as depicted in the coordinate axes of FIG. 2), such that carts 104 moving along the track 102 move upward in the vertical direction as they travel along the ascending portion 102a. The track 102 at the ascending portion 102a may include curvature as depicted in FIG. 2, and may wrap around a first axis that is generally parallel to the y-axis depicted in the coordinate axes of FIG. 2, forming a spiral shape around the first axis.

The connection portion 102c generally connects the track 102 at the ascending portion 102a to the track 102 at the descending portion 102b. The track 102 at the connection portion 102c may be generally level, such that the track 102 at the connection portion 102c does not move upward or downward in the vertical direction (e.g., in the +/−y-direction as depicted in the coordinate axes of FIG. 2).

The track 102 at the descending portion 102b moves downward in the vertical direction (e.g., in the −y-direction as depicted in the coordinate axes of FIG. 2), such that carts 104 moving along the track 102 move downward in the vertical direction as they travel along descending portion 102b. The track 102 at the descending portion 102b may be curved, and may wrap around a second axis that is generally parallel to the y-axis depicted in the coordinate axes of FIG. 2, forming a spiral shape around the second axis. In some embodiments, such as the embodiment shown in FIG. 2, the ascending portion 102a and the descending portion 102b may generally form symmetric shapes and may be mirror-images of one another. In other embodiments, the ascending portion 102a and the descending portion 102b may include different shapes that ascend and descend in the vertical direction, respectively. The ascending portion 102a and the descending portion 102b may allow the track 102 to extend a relatively long distance while occupying a comparatively small footprint evaluated in the x-direction and the z-direction as depicted in the coordinate axes of FIG. 2, as compared to assembly line grow pods that do not include an ascending portion 102a and a descending portion 102b. Minimizing the footprint of the assembly line grow pod 100 may be advantageous in certain applications, such as when the assembly line grow pod 100 is positioned in a crowded urban center or in other locations in which space is limited. While the embodiment of the assembly line grow pod 100 depicted in FIG. 2 includes a single ascending portion 102a and a single descending portion 102b, it should be understood that assembly line grow pods according to the present disclosure may include any suitable number of ascending portions 102a and descending portions 102b. For example, in some embodiments the assembly line grow pod may include a pair of ascending portions 102a and a pair of descending portions 102b. In another embodiments, the assembly line grow pod may include three ascending portions 102a and three descending portions 102b. The additional ascending portions 102a and descending portions 102b may further lengthen the track 102 as compared to assembly line grow pods 100 including a single ascending portion 102a and a single descending portion 102b.

Referring particularly to FIG. 3, the assembly line grow pod 100 generally includes a seeder system 108, a lighting system 206, a harvester system 208, and a sanitizer system 210. In the embodiment depicted in FIG. 3, the seeder system 108 is positioned on the ascending portion 102a of the assembly line grow pod 100 and defines a seeding region 109 of the assembly line grow pod 100. In embodiments, the harvester system 208 is positioned on the descending portion 102b of the assembly line grow pod 100 and defines a harvesting region 209 of the assembly line grow pod 100. In operation, carts 104 may initially pass through the seeding region 109, travel up the ascending portion 102a of the assembly line grow pod 100, down the descending portion 102b, and into the harvesting region 209.

The lighting system 206 includes one or more electromagnetic sources to provide light waves in one or more predetermined wavelengths that may facilitate plant growth. Electromagnetic sources of the lighting system 206 may generally be positioned on the underside of the track 102 such that the electromagnetic sources can illuminate plant matter in the carts 104 on the track 102. The assembly line grow pod 100 may also include one or more sensors (not depicted) positioned on the underside of the track 102 to detect growth and/or fruit output of plant matter positioned within carts 104 on the track 102, and the one or more sensors may assist in determining when plant matter positioned within the carts 104 is ready for harvest.

The harvester system 208 generally includes mechanisms suitable for removing and harvesting plant matter from carts 104 positioned on the track 102. For example, the harvester system 208 may include one or more blades, separators, or the like configured to harvest plant matter. In some embodiments, when a cart 104 enters the harvesting region 209, the harvester system 208 may cut plant matter within the cart 104 at a predetermined height. In some embodiments, a tray of the cart 104 may be overturned to remove the plant matter within the cart 104 and into a processing container for chopping, mashing, juicing, etc. In some embodiments, plant matter may be grown in the carts 104 without the use of soil, such as by a hydroponic process or the like. In these configurations, minimal or no washing of the plant matter may be necessary prior to processing at the harvester system 208. In some embodiments, the harvester system 208 may be configured to automatically separate fruit from plant matter within a cart 104, such as via shaking, combing, etc. In embodiments, plant matter remaining on the cart 104 after harvesting may be reused in subsequent growing processes. If the plant matter is not to be reused, the plant matter within the cart 104 may be removed from the cart 104 for processing, disposal, or the like. In embodiments, different assembly line grow pods may have a different length of track 102 evaluated between the seeding region 109 and the harvesting region 209. The length of the track 102 between the seeding region 109 and the harvesting region 209 may generally be indicative of the overall size of the assembly line grow pod 100, and affects the length of time for a cart 104 to move between the seeding region 109 and the harvesting region 209. For example, the longer the track 102, the longer it may take the cart to move from the seeding region 109 to the harvesting region 209. Accordingly, nutrient recipes may be modified to accommodate longer or shorter grow times for assembly line grow pods having longer or shorter tracks 102, as described in greater detail herein.

After the plant matter within the cart 104 is harvested by the harvester system 208, the cart 104 moves to the sanitizer system 210. In embodiments in which remaining plant matter in the cart 104 after harvesting is not to be reused, the sanitizer system 210 is configured to remove the plant matter and/or other particulate matter remaining on the cart 104. The sanitizer system 210 may include any one or combination of different washing mechanisms, and may apply high pressure water, high temperature water, and/or other solutions for cleaning the cart 104 as the cart 104 passes through the sanitizer system 210. Once the remaining particulate and/or plant matter is removed in the cart 104, the cart 104 moves into the seeding region 109, where the seeder system 108 deposits seeds within the cart 104 for a subsequent growing process, as described in greater detail herein.

Referring again to FIG. 2, in embodiments, the assembly line grow pod 100 includes an airflow system 111. The airflow system 111, as depicted in FIG. 2, includes one or more airflow lines 112 that extend throughout the assembly line grow pod 100. For example, the one or more airflow lines 112 may extend up the ascending portion 102a and the descending portion 102b (e.g., generally in the +/−y-direction of the coordinate axes of FIG. 2) to ensure appropriate airflow to plant matter positioned within the carts 104 on the track 102 of the assembly line grow pod 100. The airflow system 111 may assist in maintaining plant matter within the carts 104 on the track at an appropriate temperature and pressure, and may assist in maintaining appropriate levels of atmospheric gases within the assembly line grow pod 100 (e.g., carbon dioxide, oxygen, and nitrogen levels, and the like).

In embodiments, the assembly line grow pod 100 includes the master controller 106 that is communicatively coupled to one or more of the seeder system 108, the harvester system 208 (FIG. 3), the sanitizer system 210, a watering system 107, the lighting system 206 (FIG. 3), and the airflow system 111. In some embodiments, the master controller 106 may also be communicatively coupled to one or more sensors (not depicted) positioned on the underside of the track 102. The one or more sensors may detect the level of growth of plant matter within carts 104. The one or more sensors may be configured to detect whether the growth of plant matter within a specific cart 104 indicates that the plant matter is ready for harvesting before the cart 104 reaches the harvesting region 209 (FIG. 3). If the detected growth indicates that the plant matter within a cart 104 is ready for harvest, modifications to a recipe of nutrients, water, and/or light provided to the plant matter within that cart 104, such as by the watering system 107, the lighting system 206 (FIG. 3), and/or the airflow system 111, may be made until the cart 104 reaches the harvesting region 209. For example, the recipe of nutrients, water, and/or light provide to the plant matter within the cart 104 may be changed to maintain the plant matter at a certain stage of development ready that is ready for harvesting. Conversely, the detected growth of plant matter within the cart 104 indicates that the plant matter is not ready for harvesting when the cart 104 reaches the harvester system 208, the master controller 106 may command the cart 104 may to go on another lap through the assembly line grow pod 100 (e.g., up the ascending portion 102a, and down the descending portion 102b). This additional lap may include a different dosing of light, water, nutrients, etc. and the speed of the cart 104 could change, based on the development of the plant matter on the cart 104. If it is determined that the plant matter on a cart 104 is ready for harvesting, the harvester system 208 may remove the plant matter from the cart 104 and cut or otherwise process the plant matter in a harvesting process.

In embodiments, the assembly line grow pod includes the watering system 107 that generally includes one or more water lines 110, which distribute water and/or nutrients to carts 104 at predetermined areas of the assembly line grow pod 100. For example, in the embodiment depicted in FIG. 2, the one or more water lines 110 extend up the ascending portion 102a and the descending portion 102b (e.g., generally in the +/−y-direction of the coordinate axes of FIG. 2) to distribute water and nutrients to plant matter within carts 104 on the track 102.

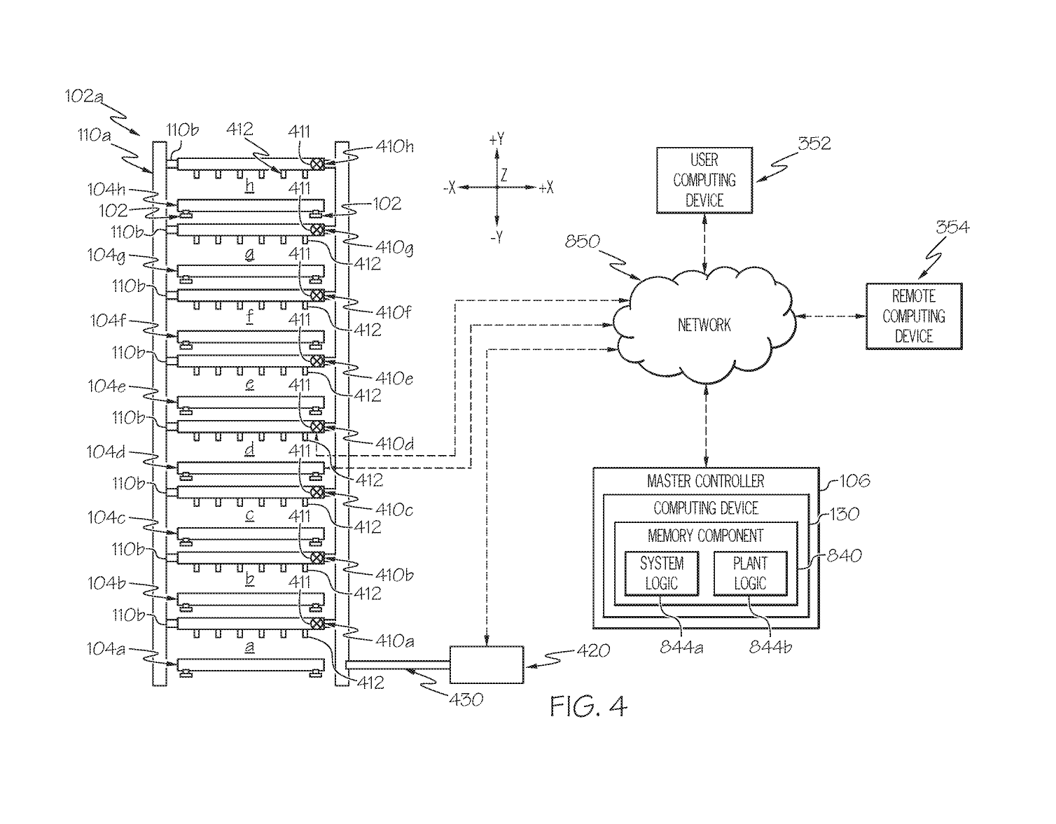

Referring to FIG. 4, a cross-section of the ascending portion 102a of the assembly line grow pod 100 is schematically depicted along section 4-4 of FIG. 2. As described above, the ascending portion 102a and the descending portion 102b (FIG. 2) of the assembly line grow pod 100 are generally symmetric, and while the cross-section of the ascending portion 102a is depicted in FIG. 4, it should be understood that a cross-section of the descending portion 102b is substantially the same. The track 102 of the assembly line grow pod 100 may wrap around an axis at the ascending portion 102a such that the track 102 forms different levels a-h on top of one another in the vertical direction (e.g., in the +y-direction of the coordinate axes depicted in FIG. 4). In the embodiment depicted in FIG. 4, a plurality of carts 104a-h are depicted at levels a-h of the assembly line grow pod 100, respectively. As the carts 104a-h move along the track 102 at the ascending portion 102a, they move upward in the vertical direction (e.g., in the +y-direction as depicted in FIG. 4) through the levels of the track 102. For example, the cart 104a will be at the position currently occupied by cart 104b on level b after a certain period of time (e.g., 6 hours), and the cart 104b will be at the position currently occupied by cart 104c on level c after the certain period of time, as each of the carts 104a-h move upward in the vertical direction (e.g., in the +y-direction as depicted in FIG. 4).

In FIG. 4, two vertical water lines 110a extend in the vertical direction (e.g., in +/−y-direction of the coordinate axes of FIG. 4) on each side of the track 102, and a plurality of horizontal water lines 110b extend in a horizontal direction (e.g., in the +x-direction of the coordinate axes of FIG. 4) at each of the levels a-h of the track 102. While two water lines 110a are depicted in the embodiment of FIG. 4, it should be understood that the assembly line grow pod 100 may include any suitable number of water lines or a single water line extending in the vertical direction. The vertical water lines 110a may be connected to a water supply, such as a water tank or the like, that supplies water to the vertical water lines 110a. On each of the levels a-h of the track 102, a horizontal water line 110b is connected between the two vertical water lines 110a.

The assembly line grow pod 100 includes a nutrient doser 420 in fluid communication with at least one of the vertical water lines 110a through a nutrient channel 430. The nutrient doser 420 is configured to dispense nutrients into the vertical water line 110a to form a nutrient/water mixture that passes through the vertical water line 110a. The nutrient/water mixture may pass through the vertical water line 110a to the horizontal water lines 110b, and is dispensed from the horizontal water lines 110b to plant matter within the carts 104a-h. While the embodiment depicted in FIG. 4 includes the nutrient doser 420 fluidly coupled to the vertical water line 110a via the nutrient channel 430, it should be understood that in other embodiments, one or more nutrient dosers 420 may be in direct fluid communication with the one or more of the horizontal water lines 110b (e.g., without intermediately flowing through the nutrient channel 430 and/or the vertical water line 110b).

The nutrient doser 420 is communicatively coupled to the master controller 106. In some embodiments, the nutrient doser 420 communicates with the master controller 106 through a wired connection. In other embodiments, the nutrient doser 420 includes network interface hardware such that the nutrient doser 420 wirelessly communicates with the master controller 106 through the network 850. The operations of the nutrient doser 420 may be controlled by the master controller 106. For example, the master controller 106 sends an instruction to the nutrient doser 420 for mixing certain amount of nutrients with water, in some embodiments.

Each of the horizontal water lines 110b is coupled to one of a plurality of water manifolds 410a-410h. Each of the water manifolds 410a-410h includes a plurality of water outlets 412 that output water into a cart, such as one of carts 104a-104h, placed under the corresponding water manifold 410a-410h. While FIG. 4 depicts each of the water manifolds 410a-410h having six water outlets 412, each of the water manifolds 410a-410h may include any suitable number of water outlets 412. Furthermore, while FIG. 4 depicts the water manifolds 410a-410h, assembly line grow pods according to the present disclosure may include any suitable number of water manifolds 410, and some assembly line grow pods may include more water manifolds 410 than others.

Each of the water manifolds 410a-410h include one or more valves 411 for opening or closing the water outlets 412. Each of the water manifolds 410a-410h may output certain amount of water and/or nutrients into the carts 104a-104h passing under each of the water manifolds 410a-410h through the selective opening and closing of the one or more valves 411.

The water manifolds 410a-410h may be communicatively coupled to the master controller 106. In some embodiments, the water manifolds 410a-410h communicate with the master controller 106 through a wired connection. In other embodiments, the water manifolds 410a-410h includes network interface hardware such that the water manifolds 410a-410h wirelessly communicate with the master controller 106 through the network 850. The operation of the one or more valves 411 may be controlled by the master controller 106. For example, the master controller 106 sends an instruction to the water manifold 410a for output certain amount of nutrients containing water into the cart 104a.

In embodiments, the master controller 106 stores nutrient dosages for various plants, and instructs the water manifolds 410a-410h and the nutrient doser 420 to output a specific water/nutrient mixture to plant matter on the carts 104a-104h. The nutrient dosages stored in the master controller may include nutrient dosages associated with a type of plant matter and nutrient concentration in water. Exemplary nutrient dosages are shown in the Table 1 below.

TABLE 1
Nutrient Dosages

| | Nutrients Concentration |
|---|---|
| Plant Matter A | 100 ppm of Nitrogen, 6 ppm of Phosphorus, |
| | 70 ppm of Potassium |
| Plant Matter B | 200 ppm of Nitrogen, 11 ppm of Phosphorus, |
| | 130 ppm of Potassium |
| Plant Matter C | 150 ppm of Nitrogen, 9 ppm of Phosphorus, |
| | 140 ppm of Potassium |
| Plant Matter D | 50 ppm of Nitrogen, 3 ppm of Phosphorus, |
| | 45 ppm of Potassium |

The master controller 106 may include a computing device 130. The computing device 130 may include a memory component 840, which stores systems logic 844a and plant logic 844b. As described in more detail below, the systems logic 844a may monitor and control operations of the assembly line grow pod 100. For example, the systems logic 844a may monitor and control operations of the nutrient doser 420 as well as the water manifolds 410a through 410h. The plant logic 844b may be configured to determine and/or receive a recipe for plant growth and may facilitate implementation of the recipe via the systems logic 844a. For example, a recipe for a plant determined by the plant logic 844b includes predetermined nutrient dosages, and the systems logic 844a may instruct the nutrient doser 420 to mix water with nutrients based on the nutrients dosages.

Additionally, the master controller 106 is coupled to a network 850. The network 850 may include the internet or other wide area network, a local network, such as a local area network, a near field network, such as Bluetooth or a near field communication (NFC) network. The water manifolds 410a-410h and/or the nutrient doser 420 may be coupled to the network 850. The network 850 is also coupled to a user computing device 352 and/or a remote computing device 354. The user computing device 352 may include a personal computer, laptop, mobile device, tablet, server, etc. and may be utilized as an interface with a user. As an example, a user may send nutrient dosages to the master controller 106 for implementation by the assembly line grow pod 100.

Similarly, the remote computing device 354 may include a server, personal computer, tablet, mobile device, etc. and may be utilized for machine to machine communications. As an example, if the master controller 106 determines a type of seed being used (and/or other information, such as ambient conditions), the master controller 106 may communicate with the remote computing device 354 to retrieve a previously stored recipe for those conditions. As such, some embodiments may utilize an application program interface (API) to facilitate this or other computer-to-computer communications.

The master controller 106 may identify the plants (e.g., as one of the types of plant matter A-D as shown in Table 1 above) in the carts 104a-104h. For example, the master controller 106 may communicate with the carts 104a-104h and receive information about the plant matter in the carts 104a-104h. As another example, the information about the plant matter in the carts 104a-104h may be pre-stored in the master controller 106 when the seeder system 108 (FIG. 3) seeds the plant matter in the carts 104a-104h.

Once the identification of plant matter in the carts 104a-104h is determined, the master controller 106 instructs the nutrient doser 420 to mix water with nutrients based on nutrient dosages. As one example, the master controller 106 may determine that each of the carts 104a-104h carry plant matter A, as identified above in Table 1. Then, the master controller 106 instructs the nutrient doser 420 to mix water with nutrients to make water having 100 ppm of Nitrogen, 6 ppm of Phosphorus, and 70 ppm of Potassium based on the nutrient dosage for plant A, as shown in the Table 1 above. As another example, if the master controller 106 determines that the carts 104a-104h carry plant matter B, the master controller 106 instructs the nutrient doser 420 to mix water with nutrients to make water having 200 ppm of Nitrogen, 11 ppm of Phosphorus, 130 ppm of Potassium based on the nutrient dosage for plant matter B as shown in the Table 1 above. The nutrient doser 420 may change the nutrient concentration of water provided to the vertical water line 110a, in real-time according to the identification of plants being carried in the carts 104a-104h.

In embodiments, the nutrient dosages for plants may be updated based on information on harvested plants. For example, if the harvested plant matter A is generally smaller in size than an ideal plant matter A, the nutrient dosages for plant matter A may be adjusted to raise the concentration of Nitrogen, such as via a user input into the user computing device 352. As for another example, if the fruits of the harvested plant matter B are not as big as ideal fruits for the plant matter B, the nutrient dosages for plant matter B may be adjusted to raise the concentration of Phosphorus.

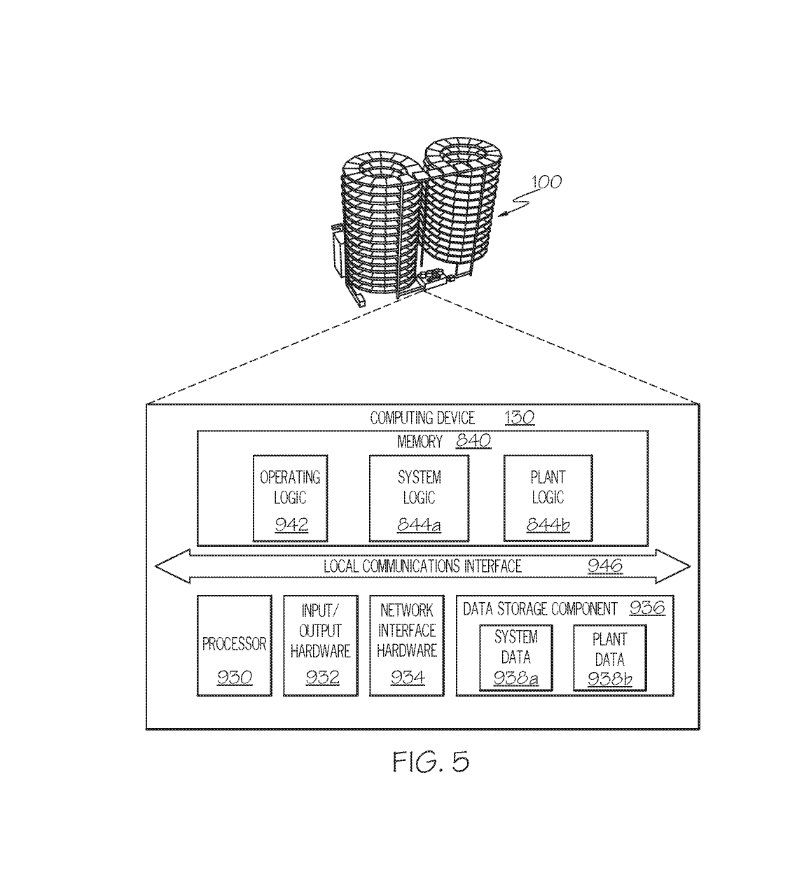

FIG. 5 depicts a computing device 130 for an assembly line grow pod 100, according to embodiments described herein. As illustrated, the computing device 130 includes a processor 930, input/output hardware 932, the network interface hardware 934, a data storage component 936 (which stores systems data 938a, plant data 938b, and/or other data), and the memory component 840. The memory component 840 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the computing device 130 and/or external to the computing device 130.

The memory component 840 may store operating logic 942, the systems logic 844a, and the plant logic 844b. The systems logic 844a and the plant logic 844b may each include a plurality of different pieces of logic, each of which may be embodied as a computer program, firmware, and/or hardware, as an example. A local interface 946 is also included in FIG. 5 and may be implemented as a bus or other communication interface to facilitate communication among the components of the computing device 130.

The processor 930 may include any processing component operable to receive and execute instructions (such as from a data storage component 936 and/or the memory component 840). The input/output hardware 932 may include and/or be configured to interface with microphones, speakers, a display, and/or other hardware.

The network interface hardware 934 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 130 and other computing devices, such as the user computing device 352 and/or remote computing device 354.

The operating logic 942 may include an operating system and/or other software for managing components of the computing device 130. As also discussed above, systems logic 844a and the plant logic 844b may reside in the memory component 840 and may be configured to perform the functionality described herein.

It should be understood that while the components in FIG. 5 are illustrated as residing within the computing device 130, this is merely an example. In some embodiments, one or more of the components may reside external to the computing device 130. It should also be understood that, while the computing device 130 is illustrated as a single device, this is also merely an example. In some embodiments, the systems logic 844a and the plant logic 844b may reside on different computing devices. As an example, one or more of the functionalities and/or components described herein may be provided by the user computing device 352 and/or remote computing device 354.

Additionally, while the computing device 130 is illustrated with the systems logic 844a and the plant logic 844b as separate logical components, this is also an example. In some embodiments, a single piece of logic (and/or or several linked modules) may cause the computing device 130 to provide the described functionality.

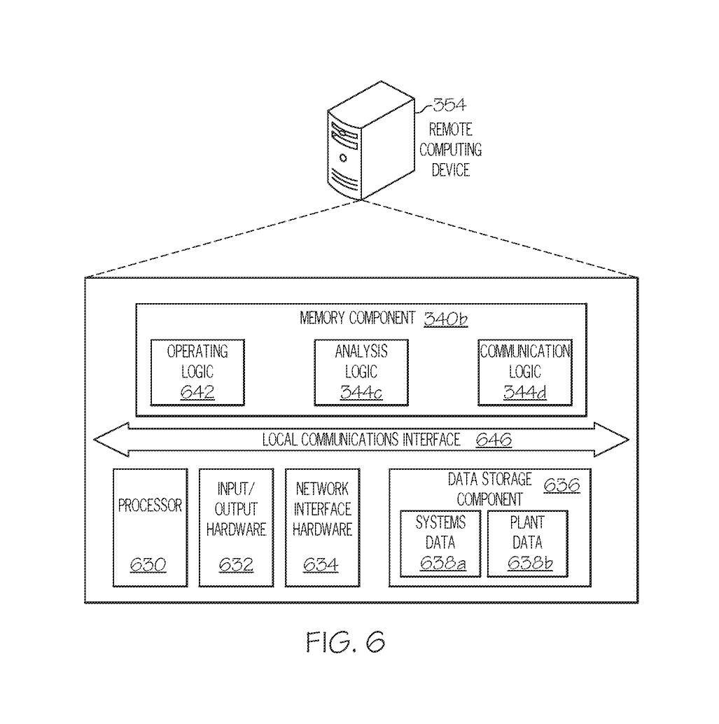

Referring now to FIG. 6, the remote computing device 354 is depicted, according to embodiments described herein. The remote computing device 354 may communicatively couple multiple assembly line grow pods to one another and/or facilitate the sharing of nutrient recipes between assembly line grow pods. As illustrated, the remote computing device 354 includes a processor 630, input/output hardware 632, the network interface hardware 634, a data storage component 636 (which stores systems data 638a, plant data 638b, and/or other data), and the memory component 340b. The memory component 340b may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 354 and/or external to the remote computing device 354.

The memory component 340b may store operating logic 642, the analysis logic 344c, and the communication logic 344d. The analysis logic 344c and the communication logic 344d may each include a plurality of different pieces of logic, each of which may be embodied as a computer program, firmware, and/or hardware, as an example. A local interface 646 is also included in the remote computing device 354, and may be implemented as a bus or other communication interface to facilitate communication among the components of the remote computing device 354.

The processor 630 may include any processing component operable to receive and execute instructions (such as from a data storage component 636 and/or the memory component 340). The input/output hardware 632 may include and/or be configured to interface with microphones, speakers, a display, and/or other hardware.

The network interface hardware 634 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the remote computing device 354 and other computing devices, such as the user computing device 352 and/or computing device 130.

The operating logic 642 may include an operating system and/or other software for managing components of the remote computing device 354. As also discussed above, analysis logic 344c and the communication logic 344d may reside in the memory component 340b and may be configured to perform the functionality, as described herein.

It should be understood that while the components in FIG. 6 are illustrated as residing within the remote computing device 354, this is merely an example. In some embodiments, one or more of the components may reside external to the remote computing device 354. It should also be understood that, while the remote computing device 354 is illustrated as a single device, this is also merely an example. In some embodiments, the analysis logic 344c and the communication logic 344d may reside on different computing devices. As an example, one or more of the functionalities and/or components described herein may be provided by the user computing device 352 (FIG. 4) and/or the computing device 130 (FIG. 4).

Additionally, while the remote computing device 354 is illustrated with the analysis logic 344c and the communication logic 344d as separate logical components, this is merely exemplary. In some embodiments, a single piece of logic (and/or or several linked modules) may cause the remote computing device 354 to provide the described functionality.

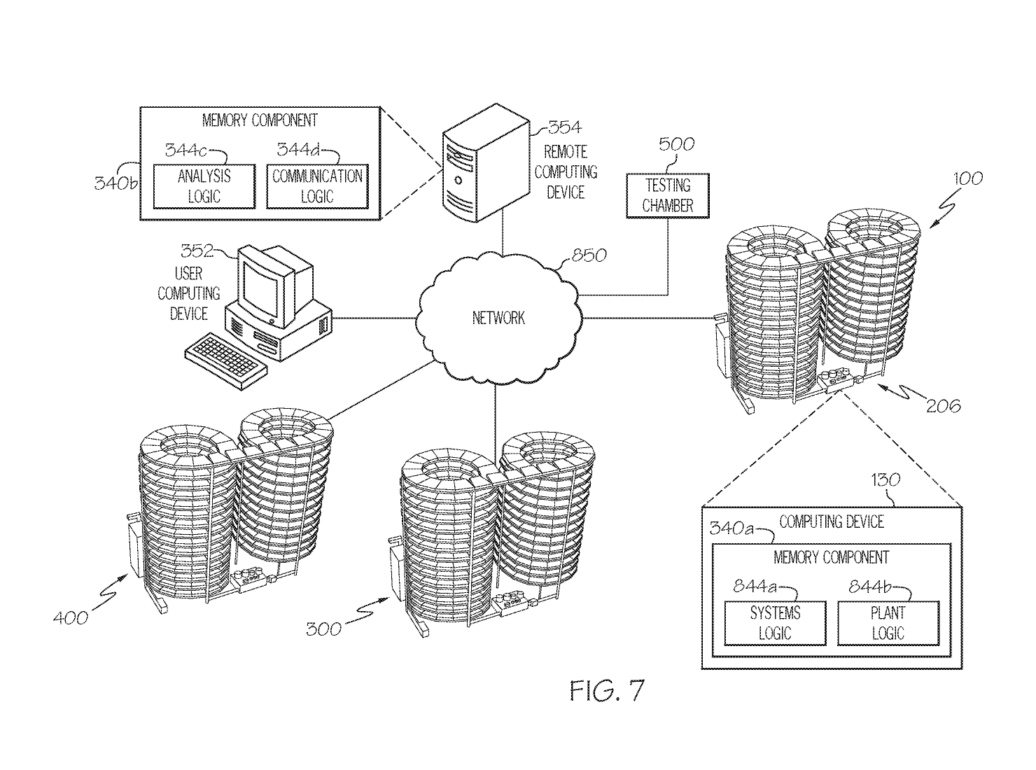

Referring to FIG. 7, the assembly line grow pod 100 is coupled to a network 850. The network 850 may include the internet or other wide area network, a local network, such as a local area network, a near field network, such as Bluetooth or a near field communication (NFC) network. The network 850 is also coupled to the user computing device 352, the remote computing device 354, and one or more other grow pods, such as a second assembly line grow pod 300 and/or a third assembly line grow pod 400. In some embodiments, the network 850 is connected to a testing chamber 500. In some embodiments, a cart 104 may be positioned in a testing chamber 500 in which the cart 104 is generally stationary or travels along a comparatively short track 102. Nutrients may be provided to plant matter on the cart 104 in the testing chamber 500, and the plant matter may be grown in the cart 104 under conditions similar to that of the assembly line grow pod 100 (e.g., with a similar grow time, a similar application of light, etc.).

Recipes and improved recipes may be communicated between the remote computing device 354, the user computing device 352, the assembly line grow pod 100 and the second and third assembly line grow pods 300, 400 via the network 850. For example, the remote computing device 354 may send a recipe to the computing device 130 for implementation by the assembly line grow pod 100.

In some embodiments, the analysis logic 344c of the remote computing device 354 may be configured to receive a recipe, an update to a recipe, and/or an upgrade to a recipe such as from the user computing device 352. The analysis logic 344c may then determine differences between the received recipe and a stored recipe that is stored by the remote computing device 354. If the differences satisfy a predetermined threshold, the remote computing device 354 may alter the stored recipe and/or save the received recipe for communicating the update and/or upgrade to the grow pods 100, 300, 400 via the communication logic 344d. In embodiments, the predetermined threshold may include a configurable threshold that is selected to achieve a desired increase in crop yield or other measurable output of the assembly line grow pods 100, 300, 400, as described in greater detail herein. Additionally, the analysis logic 344c may be configured to determine a compensation mechanism for the user based on the changes made to the recipe and/or assembly line grow pod 100 and facilitate payment of the determined compensation. As such, the remote computing device 354 may include and/or be coupled with an invoicing server, a payments server, and/or other computing device for actually making and/or accounting for the compensation to be paid to the user.

Various methods for modifying recipes and identifying modified recipes for growing plant matter within an assembly line grow pod, such as the assembly line grow pod 100 are described below.

Referring collectively to FIGS. 3, 4, 7, and 8, a flowchart for implementing a modified recipe is depicted. At block 802, a first modified recipe is received from a first assembly line grow pod 100, the first assembly line grow pod 100 comprising a first physical parameter. At block 804, a request is received from the second assembly line grow pod 300 for a modified recipe, such as via the network 850. At block 806, if the second assembly line grow pod 300 comprises the first physical parameter, then at block 810, the first modified recipe is implemented at the second assembly line grow pod 300. At block 806, if the second assembly line grow pod 300 does not comprise the first physical parameter, then at block 808, a stored recipe is implemented at the second assembly line grow pod 300.

It should be understood that blocks 802-810 may be performed by a suitable computing device, such as the computing device 130, the remote computing device 354, and/or the user computing device 352. As described above, a recipe may be utilized to facilitate growth of plant matter within an assembly line grow pod, such as the assembly line grow pods 100, 300, 400. The recipe may include nutrient doses to be applied to plant matter within carts 104 in the assembly line grow pods 100, 300, 400, such as via the nutrient doser 420. In some embodiments, the recipe may include other parameters, such as an amount of light provided by the lighting system 206, a preferred temperature of the grow pod (as may be maintained by the airflow system 111 depicted in FIG. 3), a grow time of the plant matter in the assembly line grow pod 100, or the like. As described above, the recipe may be modified to improve the results of the growing process, such as by increasing a crop yield, root growth, stem growth, chlorophyll level, leaf growth, fruit output, or the like. Alternatively or additionally, the recipe may be modified to reduce energy usage of the assembly line grow pod 100, 300, 400 (e.g., by reducing the expenditure of power by the lighting system 206, the airflow system 111, and/or the expenditure of water by the watering system 107 (FIG. 2)).

In embodiments, the first physical parameter of the first assembly line grow pod 100 may include a length of the track 102 evaluated between the harvesting region 209 and the seeding region 108 of the first assembly line grow pod 100. In general, the length of the track 102 of the first assembly line grow pod 100 may be indicative of the overall size of the assembly line grow pod 100, and may be related a grow time of plant matter grown in the assembly line grow pod 100. For example, the longer the distance between the seeding region 108 and the harvesting region 209, the longer it may take a cart 104 to move from the seeding region 108 to the harvesting region 209, resulting in a longer grow time. Accordingly, recipes suitable for an assembly line grow pods with comparatively long tracks 102 (evaluated between the seeding region 108 and the harvesting region 209) may not be suitable for assembly line grow pods having comparatively shorter tracks 102.

In other embodiments the first physical parameter may include other physical features of the assembly line grow pod 100 that may have an impact on the effectiveness of a recipe. For example and without limitation, the first physical parameter may include an area occupied by the assembly line grow pod 100, an overall height of the assembly line grow pod 100 evaluated in the vertical direction (e.g., in the +/−y-direction of the coordinate axes depicted in FIG. 2), a number of carts 104 positioned on the assembly line grow pod 100, a number of ascending portions 102a and/or descending portions 102b (e.g., pillars) of the assembly line grow pod 100, a number of water manifolds 410a-h, or the like.

By confirming that the assembly line grow pods 100, 300 both comprise the same first physical feature, the system (e.g., the computing device 130, the remote computing device 354, and/or the user computing device 352) may ensure that the first modified recipe is appropriate for use in the second assembly line grow pod 300. If the assembly line grow pods 100, 300 do not comprise the same first physical feature, as described above, a stored recipe may be implemented at the second assembly line grow pod 300. For example, the stored recipe may be appropriate for a physical feature (e.g., a length of the track, an overall size, an overall height, etc.) of the second assembly line grow pod 300. Alternatively, the second assembly line grow pod 300 may implement a modified recipe from another assembly line grow pod comprising the second physical feature if the assembly line grow pods 100, 300 do not comprise the same first physical feature.

Referring collectively to FIGS. 3, 4, 7, and 9, another flowchart for implementing a modified recipe is depicted. At block 902, a first modified recipe is received from a first assembly line grow pod 100. At block 904, an output of plant matter from the first modified recipe is detected. At block 906, if the detected output exceeds a predetermined threshold, then at block 910, the first modified recipe is implemented at the second assembly line grow pod 300. If at block 906, if the detected output exceeds a predetermined threshold, then at block 908, a stored recipe is implemented at the second assembly line grow pod 300.

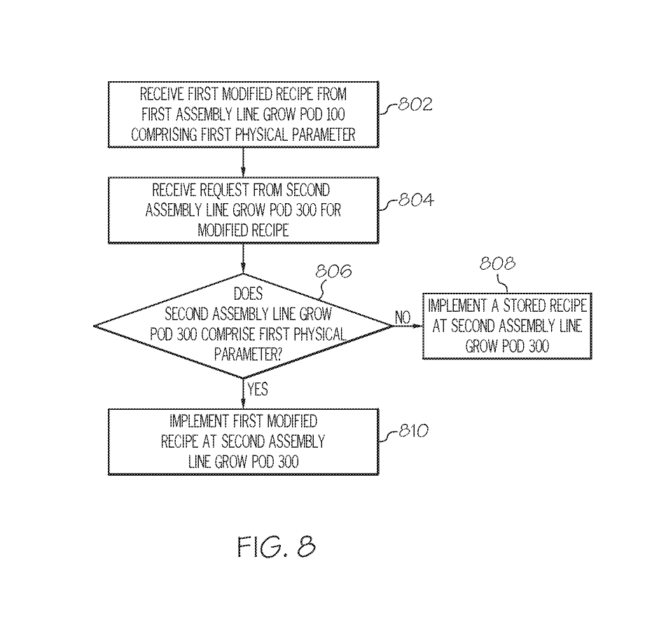

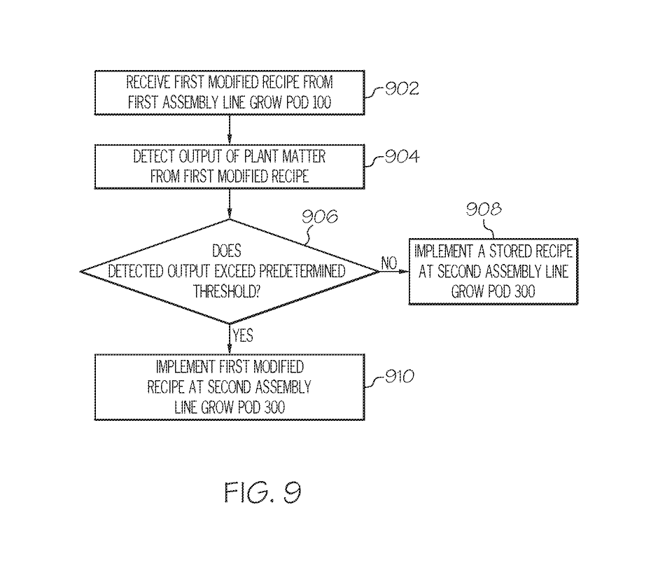

It should be understood that blocks 902-910 may be performed by a suitable computing device, such as the computing device 130, the remote computing device 354, and/or the user computing device 352. Furthermore the method depicted in FIG. 9 may be performed simultaneously with other methods, such as the method depicted in FIG. 8 and described above. At block 904, the output of the plant matter may include any suitable desired measurable output, such as crop yield, root growth, stem growth, chlorophyll level, leaf growth, or fruit output of the plant matter grown. In embodiments, the predetermined threshold may include any suitable criteria for determining that the modified recipe surpasses results obtained by a previously stored recipe. For example, in one embodiment, the predetermined threshold is a 1% increase in crop yield as compared to the current stored recipe. In another embodiment, the predetermined threshold is a 5% increase in crop yield as compared to the current stored recipe. In yet another embodiment, the predetermined threshold is a 10% increase in crop yield as compared to the current stored recipe. In other embodiments, the predetermined threshold may include thresholds related to other measurable performance of the assembly line grow pod 100. By determining if the modified recipe results in an improvement over a predetermined threshold, effectiveness of a modified recipe may be verified before implementing the modified recipe on a second assembly line grow pod 300.

Referring collectively to FIGS. 3, 4, 7, and 10, another flowchart for implementing a modified recipe is depicted. At block 1002, a stored recipe is retrieved, such as from the plant logic 844b of the computing device 130 and/or from the remote computing device 354. The stored recipe may be based on an identified type of plant matter and/or a physical feature of the assembly line grow pod 100 retrieving the stored recipe. At block 1004, at least one parameter of the stored recipe is modified to create a modified recipe. At block 1006, nutrients are dispensed to the carts 104 in accordance with the modified recipe, for example by the nutrient doser 420. At block 1008, output of plant matter within the carts 104 is detected. At block 1010, if the output of the plant matter exceeds a predetermined threshold, then at block 1012, the modified recipe is stored in the computing device 130, the remote computing device 354, and/or the user computing device 352. At block 1010, if the output of plant matter does not exceed the predetermined threshold, then the system (e.g., the computing device 130, the remote computing device 354, and/or the user computing device 352) returns to block 1004.

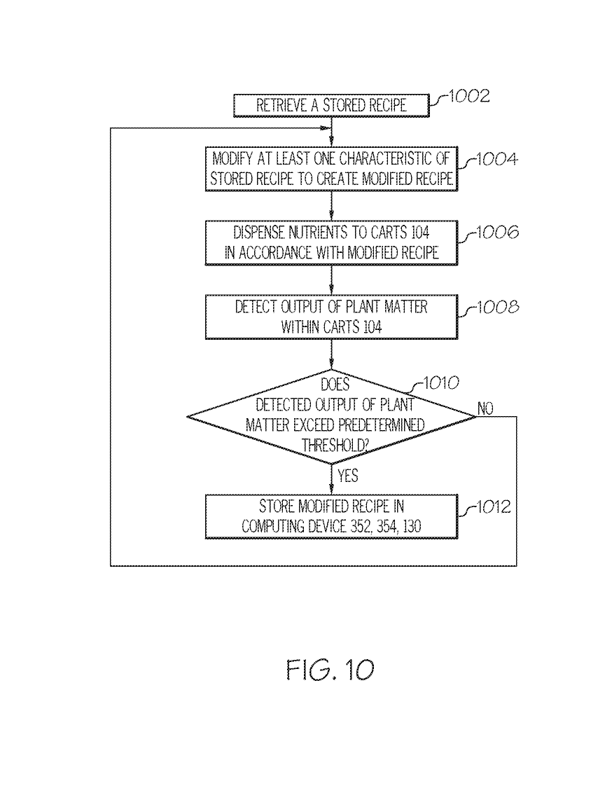

It should be understood that blocks 1002-1012 may be performed by a suitable computing device, such as the computing device 130, the remote computing device 354, and/or the user computing device 352. Furthermore the method depicted in FIG. 10 may be performed simultaneously with other methods, such as the methods depicted in FIGS. 8 and 9 and described above. At block 1008, the output of the plant matter may include any suitable desired measurable output, such as crop yield, root growth, stem growth, chlorophyll level, leaf growth, or fruit output of the plant matter grown. In embodiments, the predetermined threshold may include any suitable basis for determining that the modified recipe surpasses results obtained by a previously stored recipe. For example, in one embodiment, the predetermined threshold is a 1% increase in crop yield as compared to the current stored recipe. In another embodiment, the predetermined threshold is a 5% increase in crop yield as compared to the current stored recipe. In yet another embodiment, the predetermined threshold is a 10% increase in crop yield as compared to the current stored recipe. In other embodiments, the predetermined threshold may include thresholds related to other measurable performance of the assembly line grow pod 100. By determining if the modified recipe results in an improvement over a predetermined threshold before storing the modified recipe for future use, and modifications that improve the recipe may be identified, collected, and stored. In some embodiments, the modified recipe may first be applied to a limited number of carts, for example at block 1006. Once the detected output of plant matter from dispensing the modified recipe is determined to exceed the predetermined threshold at block 1010, the stored modified recipe at block 1012 may be applied to a plurality of carts in the assembly line grow pod 100.

In some embodiments, the stored modified recipe 1012 may be evaluated by the system (e.g., the computing device 130, the remote computing device 354, and/or the user computing device 352) to determine the nature of the improvement of the stored modified recipe 1012. For example, the system (e.g., the computing device 130, the remote computing device 354, and/or the user computing device 352) may compare the stored modified recipe with other stored recipes to isolate and identify the characteristic or characteristics contributing to the improved output of the stored modified recipe. More particularly, the system (e.g., the computing device 130, the remote computing device 354, and/or the user computing device 352) may identify a parameter of the stored modified recipe that exceeds a corresponding characteristic of other stored recipes. As one example, the stored modified recipe may include a comparatively higher amount of potassium as compared to other stored recipes. In that example, the higher amount of potassium may be identified as the cause and/or one of the causes of the improved results of the stored modified recipe. By identifying the characteristic or characteristics contributing to the improved output of the stored modified recipe, other stored recipes may be modified to obtain improved results.

Referring collectively to FIGS. 3, 4, 7, and 11, another flowchart for implementing a modified recipe is depicted. At block 1102, a first recipe is received from the first assembly line grow pod 100, the first assembly line grow pod 100 including the first physical parameter. At block 1104, a request is received from the second assembly line grow pod 300 for a modified recipe. At block 1106, if the second assembly line grow pod 300 comprises the first physical parameter, then at block 1108, the first recipe is implemented at the second assembly line grow pod 300. At block 1106, if the second assembly line grow pod 300 does not comprise the first physical parameter, then at block 1110, one or more physical parameters of the second assembly line grow pod 300 are determined. At block 1112, at least one parameter of the first recipe is modified based at least in part on the determined physical parameters of the second assembly line grow pod 300 to form a modified recipe. At block 1114, the modified recipe is implemented at the second assembly line grow pod 300.

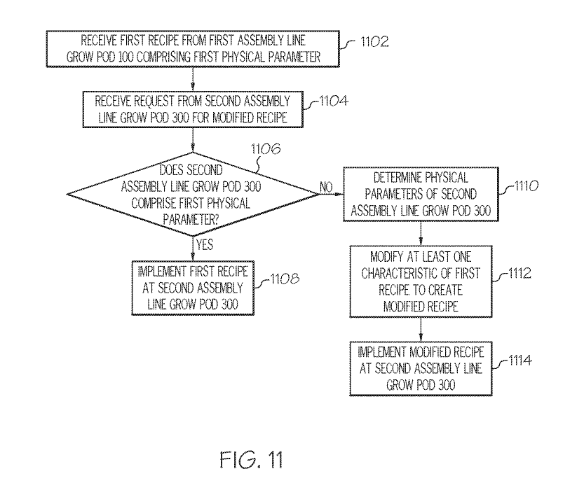

It should be understood that blocks 1102-1114 may be performed by a suitable computing device, such as the computing device 130, the remote computing device 354, and/or the user computing device 352. Furthermore the method depicted in FIG. 11 may be performed simultaneously with other methods, such as the methods depicted in FIGS. 8, 9, and 10 and described above. As described above, a recipe may be utilized to facilitate growth of plant matter within an assembly line grow pod, such as the assembly line grow pods 100, 300, 400. The recipe may include nutrient doses to be applied to plant matter within carts 104 in the assembly line grow pods 100, 300, 400, such as via the nutrient doser 420. In some embodiments, the recipe may include other parameters, such as an amount of light provided by the lighting system 206, a preferred temperature of the grow pod (as may be maintained by the airflow system 111 depicted in FIG. 3), a grow time of the plant matter in the assembly line grow pod 100, or the like. As described above, the recipe may be modified to improve the results of the growing process, such as by increasing a crop yield, root growth, stem growth, chlorophyll level, leaf growth, fruit output, or the like. Alternatively or additionally, the recipe may be modified to reduce energy usage of the assembly line grow pod 100, 300, 400 (e.g., by reducing the expenditure of power by the lighting system 206, the airflow system 111, and/or the expenditure of water by the watering system 107 (FIG. 2)).

In embodiments, the first physical parameter of the first assembly line grow pod 100 may include a length of the track 102 evaluated between the harvesting region 209 and the seeding region 108 of the first assembly line grow pod 100. In general, the length of the track 102 of the first assembly line grow pod 100 may be indicative of the overall size of the assembly line grow pod 100, and may be related a grow time of plant matter grown in the assembly line grow pod 100. For example, the longer the distance between the seeding region 108 and the harvesting region 209, the longer it may take a cart 104 to move from the seeding region 108 to the harvesting region 209, resulting in a longer grow time. Accordingly, recipes suitable for an assembly line grow pods with comparatively long tracks 102 (evaluated between the seeding region 108 and the harvesting region 209) may not be suitable for assembly line grow pods having comparatively shorter tracks 102.

In other embodiments the first physical parameter may include other physical features of the assembly line grow pod 100 that may have an impact on the effectiveness of a recipe. For example and without limitation, the first physical parameter may include an area occupied by the assembly line grow pod 100, an overall height of the assembly line grow pod 100 evaluated in the vertical direction (e.g., in the +/−y-direction of the coordinate axes depicted in FIG. 2), a number of carts 104 positioned on the assembly line grow pod 100, a number of ascending portions 102a and/or descending portions 102b (e.g., pillars) of the assembly line grow pod 100, a number of water manifolds 410a-h, or the like or the like.

By confirming that the assembly line grow pods 100, 300 both comprise the same first physical feature, the system (e.g., the computing device 130, the remote computing device 354, and/or the user computing device 352) may ensure that the first recipe is appropriate for use in the second assembly line grow pod 300. If the assembly line grow pods 100, 300 do not comprise the same first physical feature, as described above, the physical parameters of the second assembly line grow pod 300 may be determined, and at least one parameter of the first recipe is modified. As one example, if the second assembly line grow pod 300 has a longer track 102 than the first assembly line grow pod 100, then a concentration of nutrients to be applied to the carts 104 on the second assembly line grow pod 300 may be reduced. For example, the ppm concentration of nitrogen, phosphorus, and/or potassium may be reduced in the modified recipe to accommodate the comparatively longer grow time of plant matter in the second assembly line grow pod 300 owing to the comparatively longer track 102. As another example, if the second assembly line grow pod includes fewer water manifolds 410a-h than the first assembly line grow pod 100, then the ppm concentration of nitrogen, phosphorus, and/or potassium may be increased in the modified recipe to accommodate the comparatively fewer opportunities for the carts 104 on the second assembly line grow pod 300 to receive a dose of nutrient(s).

In some embodiments, subsequent to implementing the modified recipe at the second assembly line grow pod 300, the output of the second assembly line grow pod 300 may be detected and compared to a predetermined threshold, and stored, as described above with respect to blocks 1008-1012 of FIG. 10. In this way, the system the system (e.g., the computing device 130, the remote computing device 354, and/or the user computing device 352) may determine the effectiveness of the modified recipe implemented at the second assembly line grow pod 300. In some embodiments, the output of the second assembly line grow pod 300 may be compared to a detected output of the first assembly line grow pod 100 utilizing the first recipe.

In some embodiments, the first recipe may be received from a testing chamber 500 at block 1102. In these embodiments, as the testing chamber 500 would not comprise the same physical parameters as the second assembly line grow pod, the system (e.g., the computing device 130, the remote computing device 354, and/or the user computing device 352) would proceed through blocks 1110 and 1112, determining the physical parameters of the second assembly line grow pod 300 and modifying at least one parameter of the first recipe received from the testing chamber 500.

As illustrated above, various embodiments for managing nutrient dosages for a grow pod are disclosed. The embodiments include systems and methods for receiving modified recipes and for modifying recipes based at least in part on physical parameters of the assembly line grow pod. By modifying the recipes and/or providing modified recipes based on physical parameters of the assembly line grow pod, the recipes may be modified to optimize plant matter output. These embodiments create a quick growing, small footprint, chemical free, low labor solution to growing microgreens and other plants for harvesting. These embodiments may create recipes and/or receive recipes that dictate the timing and wavelength of light, pressure, temperature, watering, nutrients, molecular atmosphere, and/or other variables the optimize plant growth and output. The recipe may be implemented strictly and/or modified based on results of a particular plant, tray, or crop. Furthermore by modifying the recipes and/or providing modified recipes based on physical parameters of different assembly line grow pods, similar crop outputs may be maintained across different assembly line grow pods.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for managing nutrient dosages for a grow pod. It should also be understood that these embodiments are merely exemplary and are not intended to limit the scope of this disclosure.

What is claimed is:

1. A system for implementing modified recipes in a plurality of grow pods, the system comprising:
a remote computing device communicatively coupled to an assembly line grow pod, the remote computing device comprising a processor and a computer readable and executable instruction set, which when executed, causes the processor to:
receive a first recipe associated with a first physical parameter;
receive a request from the assembly line grow pod for a recipe;
determine whether the assembly line grow pod comprises the first physical parameter;
in response to determining that the assembly line grow pod comprises the first physical parameter, implement the first recipe at the assembly line grow pod;
in response to determining that the assembly line grow pod does not comprise the first physical parameter, determine a physical parameter of the assembly line grow pod;
modify at least one characteristic of the first recipe to create a modified recipe based at least in part on the determined physical parameter of the assembly line grow pod; and
implement the modified recipe at the assembly line grow pod.

2. The system of claim 1, further comprising a testing chamber communicatively coupled to the remote computing device and wherein the executable instruction set, when executed, further causes the processor to receive the first recipe from the testing chamber.

3. The system of claim 1, further comprising a first assembly line grow pod communicatively coupled to the remote computing device and wherein:
the assembly line grow pod is a second assembly line grow pod; and
the executable instruction set, when executed, further causes the processor to receive the first recipe from the first assembly line grow pod.

4. The system of claim 3, wherein the first physical parameter comprises a length of a track evaluated between a seeding region and a harvesting region of the first assembly line grow pod and the determined physical parameter of the second assembly line grow pod comprises a length of a track evaluated between a seeding region and a harvesting region of the second assembly line grow pod, and wherein the executable instruction set, when executed, further causes the processor to:
determine that the determined physical parameter of the second assembly line grow pod is less than the first physical parameter; and
modify the at least one characteristic of the first recipe to decrease a concentration of nutrients to be provided at the second assembly line grow pod in response to determining that the determined physical parameter of the second assembly line grow pod is less than the first physical parameter.

5. The system of claim 3, wherein the first physical parameter comprises a number of water manifolds of the first assembly line grow pod and the determined physical parameter of the second assembly line grow pod comprises a number of water manifolds of the second assembly line grow pod, and wherein the executable instruction set, when executed, further causes the processor to:
determine that the determined physical parameter of the second assembly line grow pod is less than the first physical parameter; and
modify the at least one characteristic of the first recipe to increase a concentration of nutrients to be provided at the second assembly line grow pod in response to determining that the determined physical parameter of the second assembly line grow pod is less than the first physical parameter.

6. The system of claim 1, wherein the executable instruction set, when executed, further causes the processor to:
compare output results of the first recipe with output results of a first stored recipe associated with the first physical parameter;
determine that the output results of the first recipe satisfy a predetermined threshold over the output results of the first stored recipe; and
in response to determining that the that the output results of the first recipe satisfy the predetermined threshold and that the assembly line grow pod comprises the first physical parameter, implement the first recipe at the assembly line grow pod.

7. The system of claim 6, wherein the executable instruction set, when executed, further causes the processor to:
compare the first recipe to the first stored recipe;
identify a characteristic of the first recipe that exceeds a corresponding characteristic of the first stored recipe; and
change the first stored recipe to include the characteristic of the first recipe.

8. A method for applying recipes in a plurality of assembly line grow pods, the method comprising:
receiving a first modified recipe from a first assembly line grow pod, the first assembly line grow pod comprising a first physical parameter;
receiving a second modified recipe from a second assembly line grow pod, the second assembly line grow pod comprising a second physical parameter that is different than the first physical parameter;
receiving a request from a third assembly line grow pod for a modified recipe;
determining that the third assembly line grow pod comprises the first physical parameter or the second physical parameter;
in response to determining that the third assembly line grow pod comprises the first physical parameter, implementing the first modified recipe at the third assembly line grow pod; and
in response to determining that the third assembly line grow pod comprises the second physical parameter, implementing the second modified recipe at the third assembly line grow pod.

9. The method of claim 8, wherein the first physical parameter comprises a length of a track evaluated between a harvesting region of the first assembly line grow pod and a seeding region of the first assembly line grow pod, and the second physical parameter comprises a length of a track evaluated between a harvesting region of the second assembly line grow pod and a seeding region of the second assembly line grow pod.

10. The method of claim 8, wherein the first physical parameter comprises a number of water manifolds of the first assembly line grow pod and the determined physical parameter of the second assembly line grow pod comprises a number of water manifolds of the second assembly line grow pod.

11. The method of claim 8, further comprising:
in response to determining that the third assembly line grow pod does not comprise the first physical parameter and does not comprise the second physical parameter, determining a third physical parameter of the third assembly line grow pod;
modifying at least one characteristic of the first modified recipe to create a modified recipe based at least in part on the determined physical parameter of the third assembly line grow pod; and
implementing the modified recipe at the third assembly line grow pod.

12. The method of claim 8, further comprising:
comparing output results of the first modified recipe of the first assembly line grow pod with output results of a first stored recipe associated with the first physical parameter;
determining that the output results of the first modified recipe satisfy a predetermined threshold over the output results of the first stored recipe; and
wherein implementing the first modified recipe is in response to determining that the that the output results of the first modified recipe satisfy the predetermined threshold over the output results of the first stored recipe.

13. The method of claim 12, wherein the output results of the first modified recipe comprise at least one of root growth, stem growth, chlorophyll concentration, leaf growth, or fruit output.

14. The method of claim 12, further comprising:
comparing the first modified recipe to the first stored recipe;
identifying a characteristic of the first modified recipe that exceeds a corresponding characteristic of the first stored recipe; and
changing the first stored recipe to include the characteristic of the first modified recipe.

15. A method for implementing a recipe within an assembly line grow pod, the method comprising:
identifying a type of plant matter to be grown within the assembly line grow pod;
retrieving a stored recipe from a remote computing device based at least in part on the type of plant matter;
modifying at least one characteristic of the stored recipe to create a modified recipe based at least in part on a physical parameter of the assembly line grow pod;
dispensing nutrients to at least one cart in accordance with the modified recipe;
detecting an output of plant matter on the at least one cart from dispensing the modified recipe;
determining that the output of plant matter from dispensing the modified recipe exceeds a predetermined threshold;
in response to determining that the output of plant matter from dispensing the modified recipe exceeds the predetermined threshold, storing the modified recipe on the remote computing device; and
dispensing nutrients to a second plurality of carts in accordance with the stored modified recipe.

16. The method of claim 15, wherein the physical parameter comprises a length of a track evaluated between a harvesting region of the assembly line grow pod and a seeding region of the assembly line grow pod, and wherein modifying the at least one characteristic of the stored recipe comprises decreasing a concentration of nutrients to be provided at the assembly line grow pod in response to determining that the physical parameter is less than a physical parameter associated with the stored recipe.

17. The method of claim 15, wherein the physical parameter comprises a number of water manifolds of the assembly line grow pod, and wherein modifying the at least one characteristic of the stored recipe comprises increasing a concentration of nutrients to be provided at the assembly line grow pod in response to determining that the physical parameter is less than a physical parameter associated with the stored recipe.

18. The method of claim 15, wherein the output of plant matter from dispensing the modified recipe comprises at least one of root growth, stem growth, chlorophyll concentration, leaf growth, or fruit output.

19. The method of claim 15, wherein dispensing nutrients to the at least one cart in accordance with the modified recipe comprises dispensing the nutrients to the at least one cart within a testing chamber.

20. The method of claim 15, further comprising:
comparing the modified recipe to the stored recipe;
identifying a characteristic of the modified recipe that exceeds a corresponding characteristic of the stored recipe; and
changing the stored recipe to include the characteristic of the modified recipe.
